(19) United States
(12) Patent Application Publication
(10) Pub. No.: US 2011/0041442 A1
(43) Pub. Date: Feb. 24, 2011

(54) Fastener for lightweight concrete panel and panel assembly

(76) Inventor: Thuan Bui, Philadelphia, PA (US)

Correspondence Address: Thuan Bui, 58 N. Mascher St., Philadelphia, PA, 19106, US

(21) Appl. No.: 12/655,032

(22) Filed: Dec. 22, 2009

Related U.S. Application Data
(63) Continuation-in-part of application No. 12/583,607, filed on Aug. 23, 2009.
Application No. 12/583,607 is a continuation-in-part of application No. 12/587,851, filed on Oct. 14, 2009.

(51) Int. Cl. E04B 2/58; E04B 1/61; E04B 1/38; F16B 13/06

(52) U.S. Cl. 52/483.1; 52/582.1; 52/698; 411/34

(57) ABSTRACT

The lightweight concrete panel is comprised of a thin concrete slab, a standard steel stud frame, optional insulation strips to increase its thermal performance for exterior wall applications, and specially engineered blind rivets or screws that connect the thin concrete slab to the metal frame. The specially engineered blind rivet has a protruding and shaped head that acts as an anchor when embedded in the hardened concrete slab and has an optional elastic cover in its embedded head to allow slight movement of the concrete slab. The engineered screw with an elastic cover can also be used as the connecting device that allows slight movement of the concrete slab.

### CROSS-REFERENCE TO RELATED APPLICATIONS

This application claims the benefit of earlier application Ser. Nos. 12/583,607 filed on Aug. 23, 2009 and No. 12/587,851 filed on Oct. 14, 2009 in the U.S. Patent & Trademark Office.

### BACKGROUND OF THE INVENTION

1. Field of the Invention

The present invention relates to lightweight concrete panel with a supporting steel frame and the device that connects the concrete facing to the steel frame.

2. Description of the Related Art

The following patents define the current state of the art:

Schilger, U.S. Pat. No. 4,602,467 describes a building panel with a supporting steel frame attached to a concrete slab. The attaching mechanism that connects the steel frame to the concrete slab is part of the stud members. The flange of one side of the stud member is punched and modified in various shapes intending to act as anchor when its entire side is embedded into the concrete slab. Because of the stud's flange embedment into the concrete, the panel is considered a composite panel where both the concrete layer and the steel frame plays important role on carrying load.

Schilger, U.S. Pat. No. 4,885,884 describes a building panel with a supporting steel frame attached to a concrete slab. The attaching mechanism that connects the steel frame to the concrete slab is part of the stud members. The attaching device of this panel is not one long section extending one whole side of the stud member like his earlier art U.S. Pat. No. 4,602,467. Instead, the multiple connecting devices are the intermittingly punched and bent portions in the C-section stud's flange. The punched and bent sections can be L-shaped, V-shaped, and T-shaped sections that run parallel to the stud member and extend into the concrete slab, acting as the connecting devices.

Ruiz, U.S. Pat. No. 6,151,858 has a similar concept as Schilger in U.S. Pat. No. 4,885,884. Ruiz's intermittingly punched and bent sections in the stud's flange have a different shape and bent direction. Ruiz's protruding L-shaped is narrower than Schilger and bent differently. Like Schilger's protruding sections, Ruiz's punched tabs are the connecting devices that are part of the stud member.

Bodnar, U.S. Pat. No. 4,909,007 has a similar concept as Schilger, U.S. Pat. No. 4,602,467. One entire side of the C-section stud is punched and bent into one L-shaped flange, forming one long integrated attaching device to be embedded into a concrete slab. The differences in Bodnar's art are the openings in the embedded L-shaped junction flange and the large opening in the stud web area. The openings in the embedded junction flange are claimed to enable material to flow through and form a stronger concrete in the local region. The large openings in the stud web are meant to limit the thermal conductivity from one side to the other through reducing the thermal pathway or steel area in the stud web.

There are three major problems that associate with all mentioned arts: first is that they will need specially designed machinery to create such special stud with integrated connecting mean; second is their poor thermal performance; and third is the meeting of the building code specifications. Generally, the cost of specially engineered machinery to produce such modified stud is expensive and prohibiting. The thermal performance of Ruiz's and Schilger's wall panels is poor due to the direct material contact between the stud flange and the exterior concrete slab. Metal has high temperature conductivity and the heat from the exterior concrete flows right though the metal material of the stud to the inside stud flange. Although Bodnar's opened web stud is an improvement in reducing thermal conductivity in the stud web, the cost of machinery that produces the openings in stud web is expensive and prohibiting due to its complex process. Bodnar's opened web stud is an improvement, but the bottom and top tracks in his steel frame still have solid web so the panel still has poor thermal performance in those areas of the panel. In load-bearing applications, Bodnar and Schilger's wall panel will not meet the current International Building Code specifications in many parts of the country and the world. Little is known about the composite action between the concrete slab and the steel frame in their design. There is no guidance in the code specifications to cover such panel constructions. Assuming any unique composite panel is tested and proven to have structural properties, the submitting of its data and getting it specified in the code specifications can be a very long and costly process. The wide adoption of any unique composite panel is very unlikely because code specifications are written to encompass a type of construction not of any specific product. Previous arts overlooked these three major issues. The present invention was developed to overcome these major problems inherent in all prior arts.

### SUMMARY OF THE INVENTION

This invention is of a panel construction and the unique components that make it. The lightweight concrete panel is comprised of a thin concrete slab, a standard stud frame that can be load-bearing or non-load-bearing that is well studied and known to be in International Building Code specifications, optional insulation strips to increase its thermal performance for exterior wall applications, and novel anchoring blind rivets with protruding head as the preferred concrete-to-frame connecting device. Other optional concrete-to-frame connecting devices can be the combination of ordinary blind rivets and bent steel brackets that act as concrete anchors or screw with elastic covering that connects the concrete slab to the metal frame.

The standard steel studs in the supporting frame are manufactured by ordinary roll former or automated roll former with rivet or screw holes punched in stud flange. The optional insulation strip is ⅛″ to 1″ thick, extruded foam strip with adhesive backing. The insulating foam can be made from different materials to have the desired insulating properties. Some rigidity is preferred for easy handling during manufacturing process. The insulating strip can have marking or pre-punch holes that will align with the holes in the stud flange for easy installation. The anchoring blind rivet with protruding head is the preferred connecting device that connects the concrete slab to the supporting steel frame. The steel stud frame can have steel shear bracing in the interior side of the frame to meet shear load requirements as specified in building code specifications.

### BRIEF DESCRIPTION OF THE DRAWINGS

FIG. 1 illustrates the basic construction of present invention with its components.

FIG. 2 illustrates the anchoring blind rivet with protruding head as a connecting device that connects concrete slab to the steel frame.

FIG. 3 illustrates a cross-section of the anchoring blind rivet shown in FIG. 2.

FIG. 4 illustrates a cross-section of an exterior wall panel shown in FIG. 1 with its components.

FIG. 5 illustrates a cross-section of an interior panel where the insulating strip is unnecessary.

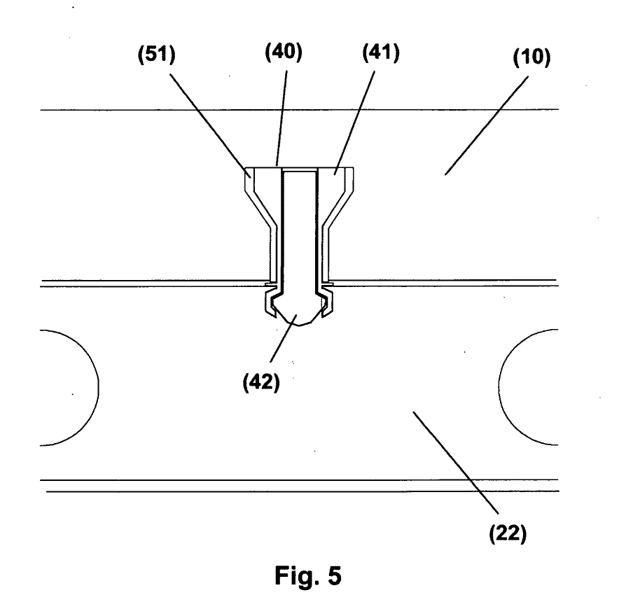

FIG. 6 illustrates a cross-section of an interior panel where a tampered head screw with elastic sleeve is the connecting device.

FIG. 7 illustrates another design of an anchoring blind rivet where the rivet body is comprised of two ordinary blind rivet bodies fitted tightly together with heads in opposite ends to effectively form the protruding rivet head.

FIG. 8. illustrates another design of an anchoring blind rivet where the rivet body is comprised of a slotted pin or sleeve fitted tightly over an ordinary blind rivet body, and where the slotted pin or sleeve portion of the rivet body is the protruding rivet head.

FIG. 9. illustrates another design of a blind rivet where the rivet body is shaped like a step-up cylinder with a dome head, and where the thicker portion of the rivet body is the protruding rivet head.

FIG. 10 illustrates another connector device type used in conjunction with an ordinary blind rivet to connect concrete to steel frame: the bent steel bracket with a hole in the center for ordinary rivet to fasten it to frame structure and with bent ends shaped to anchor itself in the concrete.

FIG. 11 illustrates another version of protruding head blind rivet with same functionality as previous version but has slightly different design.

FIG. 12 illustrates yet another embodiment of the protruding head blind rivet that has the functionality as previous versions.

### DETAILED DESCRIPTION OF THE INVENTION

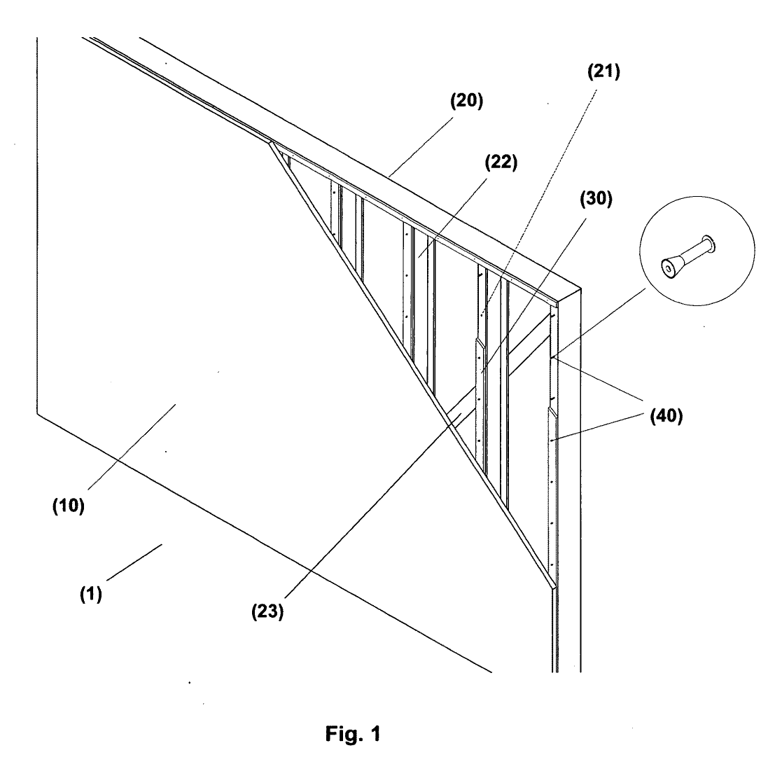

FIG. 1 illustrates an embodiment of the invention very well. The concrete panel (1) is comprised of a standard steel stud frame (20) with pre-punch holes (21) for concrete-to-stud connectors in each standard C-section stud (22), a thin ordinary concrete slab with steel mesh reinforcement or a very thin ECC (engineered cementitious composite) concrete with high amount of micro fibers as the primary reinforcement (10), optional insulating strips (30) made of various extrudable materials with high insulating property in exterior wall application, optional steel shear bracing (23) in the interior side of the frame (20) when load-bearing is required, and the specially engineered anchoring blind rivet (40) as the preferred connecting device that connects the concrete slab (10) to the steel studs (22) of the steel frame (20).

The usage of standard shaped stud (22) of heavy gauge steel and size and steel shear bracing (23) in the steel frame (20) will allow the panel to meet the building code specifications readily and will require no specialized machinery or additional machine to modify the stud flange. Implementation of this system will require much less capital at the start and its market acceptance will be higher due to usage of standard C-section studs. Utilizing the standard stud frame system also has another major advantage: we can now use the latest labor-saving technology like automated roll forming technology from FRAMECAD Group (a New Zealand company) to reduce stud frame manufacturing cost. The preferred steel frame manufacturing process would require an automated roll former that can cut both studs and tracks to required sizes, and punch holes for rivets (40) in each stud. When this technology is applied, complexity of process and labor cost is greatly reduced.

The insulating strip (30) is designed to limit the thermal conductivity in the stud flange area. Its has the width of the stud flange, thickness between 1/16″ to 1″, made of various insulating materials, has adhesive backing, and has enough rigidity to counter the weight pressure of the concrete slab when the panel is lifted or moved. In exterior applications, this insulating strip will greatly increase the panel's thermal performance. The preferred strip (30) can be extruded rigid foam and has pre-punched holes or marking on strip surface for connector rivets (40) to go through. This insulating strip (30) is an optional component as the wall panel (1) can be cast with air gap between the steel frame (10) and the concrete (20) during the manufacturing process and then can be filled after at building site or factory with spray foam that will have the same effect as having the insulating strips (30).

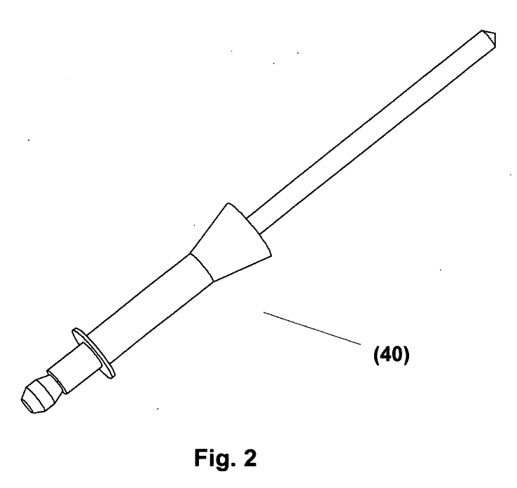

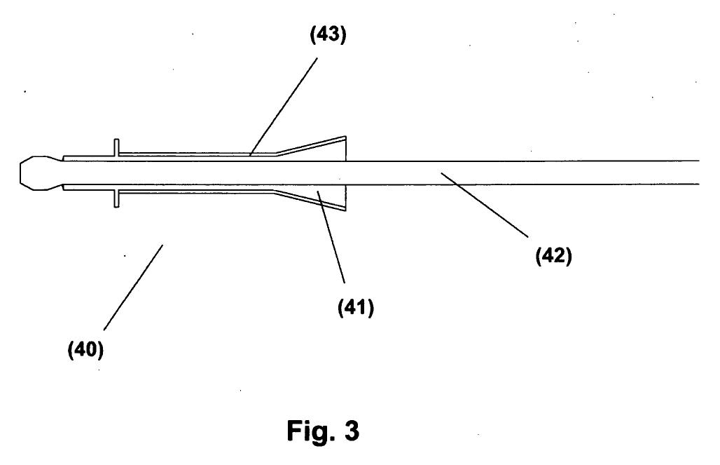

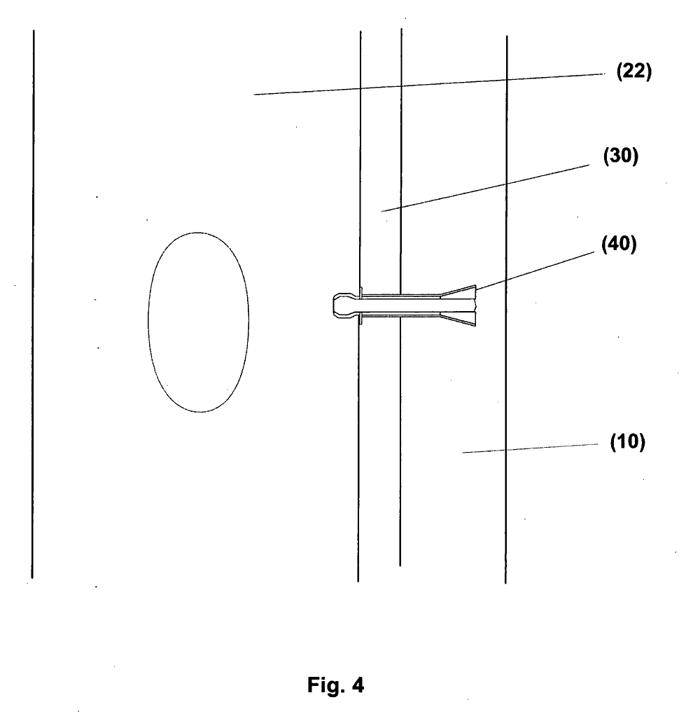

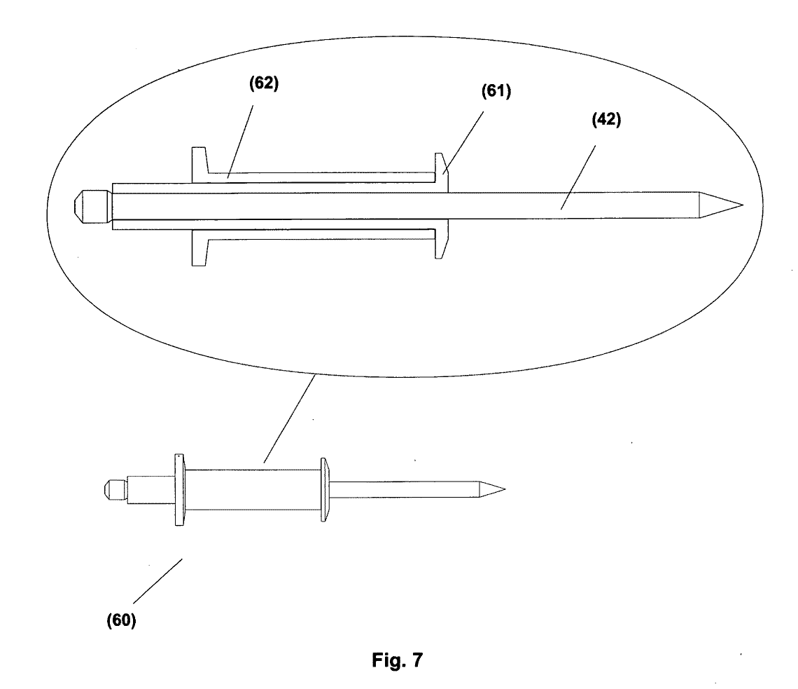

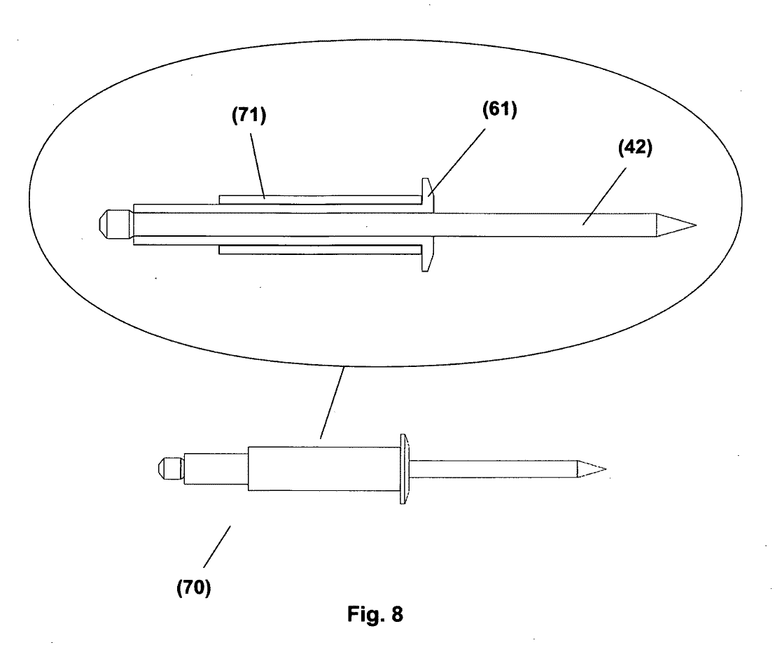

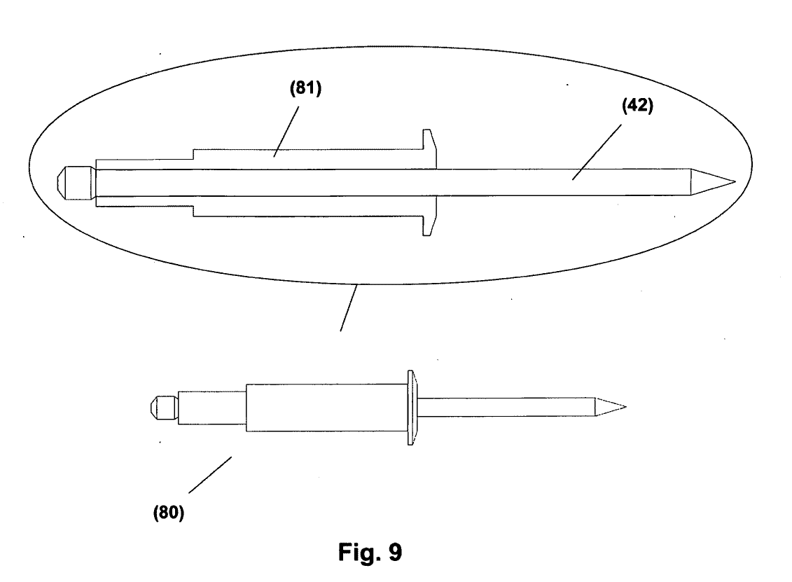

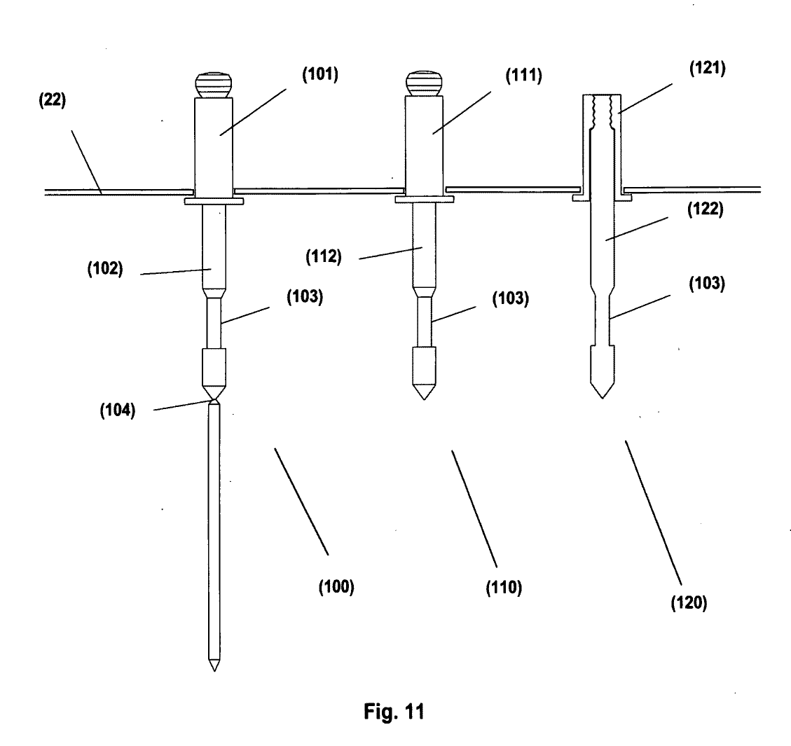

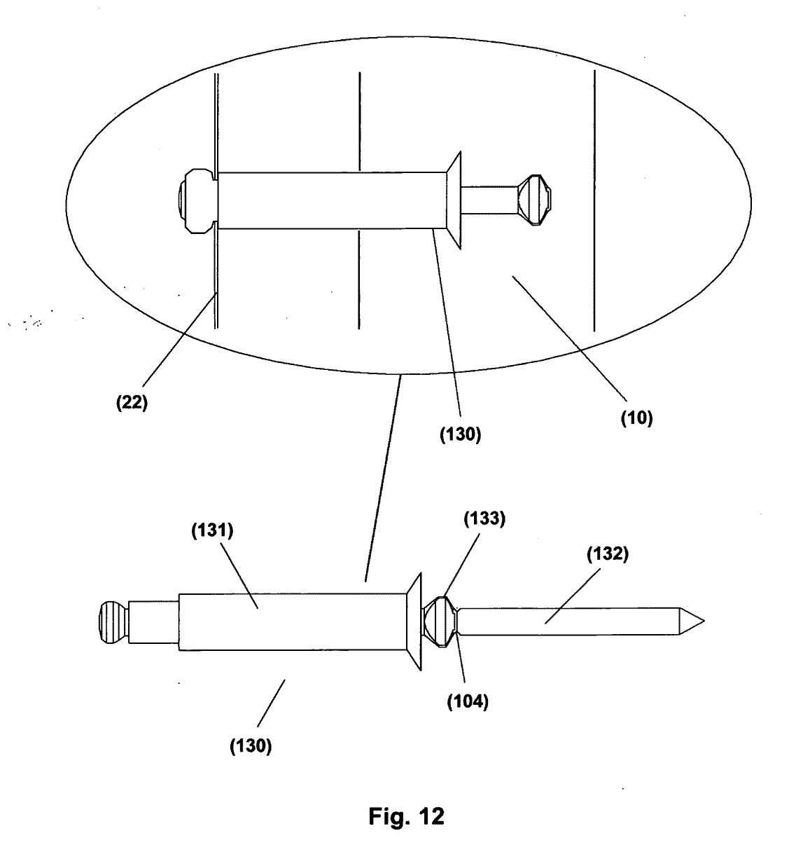

The preferred concrete-to-steel connecting device in the embodied panel is the specially engineered anchoring blind rivet with protruding head. The protruding blind rivet head can have many designs and shapes that serve as concrete anchoring mechanism. FIG. 2 illustrates one possible version of the anchoring blind rivet (40). In this version, the anchoring blind rivet (40) has a protruding and modified rivet head (41) that is shaped effectively to act as an anchor in the concrete. FIG. 3 shows the optional rivet cover (43) over the rivet head (41). The protruding rivet head (41) can have various shapes that allow it to act as an anchor in the hardened concrete. The simplest rivet head (41) shape is of a cone shape as shown in FIG. 3 and FIG. 4. The rivet cover (43) is made from various thermal plastic or elastic materials such as silicon or rubber. The usage of various thermal plastic covers in steel anchor is a general practice to help reduce the steel corrosion and reduce a little of thermal conductivity between the steel body and the concrete. The protective cover (43) may not be necessary if the rivet head (41) is made of stainless steel and the concrete slab (10) is sufficiently restrained with steel mesh reinforcement in standard concrete. However, when the concrete slab (10) is made of ECC (engineered cementitious composite) concrete and has only micro-fiber as the primary means of reinforcement, the higher dry shrinkage rate of the concrete material will cause the concrete slab (10) to shrink and move slightly more. The elastic rivet cover (43) is necessary to allow the concrete slab or plate (10) to move and reduce any internal stress of the concrete slab (10). If the shrinking concrete slab (10) is restrained the internal stress will crack concrete slab (10). This usage of elastic cover in any type of concrete anchor is novel and necessary to reduce internal stress of the concrete slab (10). The blind rivet is the preferred connecting device because it has great pull strength or holding strength and it is easier and faster to install. FIGS. 7, 8, 9, 11, and 12 illustrate other anchoring blind rivet designs that can serve as the connector. FIG. 7 illustrates a version of the protruding head blind rivet (60) where the protruding rivet head is comprised of two ordinary blind rivet bodies (61 and 62) with the smaller main rivet body (61) fitted tightly inside the larger rivet body (62). FIG. 8 illustrates another version of the protruding head blind rivet (70). The rivet body of this version is comprised of a long ordinary rivet body (61) and a simple slotted pin or sleeve (71) fitted tightly over the rivet body (61). FIG. 9 illustrates another version of the protruding head blind rivet (80) where the round rivet body (81) is shaped like a step-up cylinder. The thicker portion of the rivet body (81) is the protruding head extending from the steel frame surface. FIGS. 11 and 12 illustrate other versions of the protruding head blind rivet (100, 110, 120, and 130). FIG. 11 illustrates three protruding head bind rivet designs (100, 110, and 120), where the protruding rivet head of these three designs is protruding mandrel of the blind rivet. Normally, the mandrel of blind rivet does not extend beyond the plane of the substrate (22); but in these design, the protruding mandrel can have various shapes that provide the rivet the concrete anchoring ability. The first blind rivet design (100) is comprised of an ordinary blind rivet body (101) and a protruding mandrel (102) with shaped portion (103) that serve as the anchoring mean and the mandrel break-point (104) far in the protruding portion of the mandrel (102). The second blind rivet design (110) is similar to the first but without a mandrel break-point. This rivet will require a custom made rivet gun that will only pull the mandrel (103) and release it in place. The third blind rivet design (120) is similar to the second (110) except the rivet body is an ordinary rivet nut (121) and the mandrel (122) has a threaded end that screws to the rivet nut (121). FIG. 12 illustrates yet another possible protruding head rivet design (130). In this blind rivet design (130) the protruding head is both the protruding rivet body (131) and the protruding mandrel (132). The protruding mandrel (132) has a break-point outside the rivet body (131) beyond the shaped portion (133) in the mandrel stem that serves as the anchoring mean,

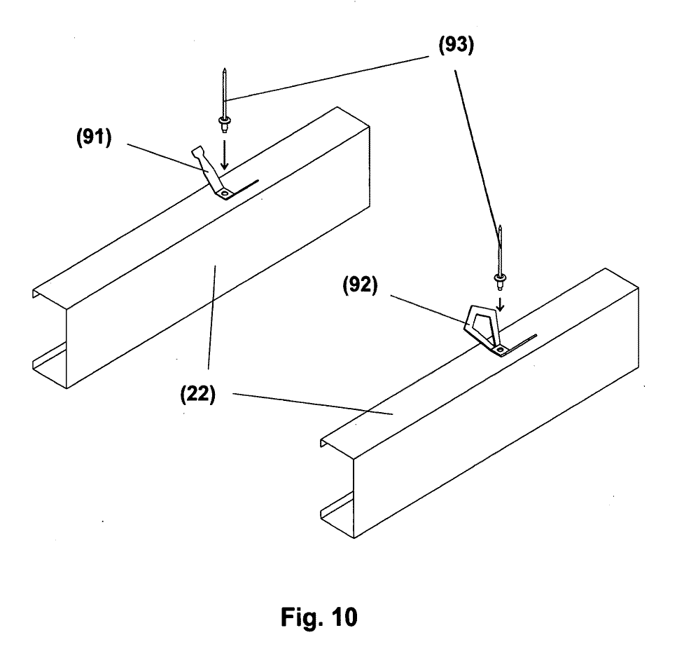

Yet another optional mean of concrete-to-frame connection disclosed in this application is the bent steel anchoring bracket (91 and 92) with hole in the center for an ordinary rivet to fasten it to frame structure and with bent ends shaped to anchor itself in the concrete. As illustrated in FIG. 10, the bent steel anchoring brackets (91 and 92) are to be used in conjunction with ordinary rivet (93) to fasten itself to the steel stud (22). The steel anchoring bracket's ends can have different shapes that help it anchor to the concrete.

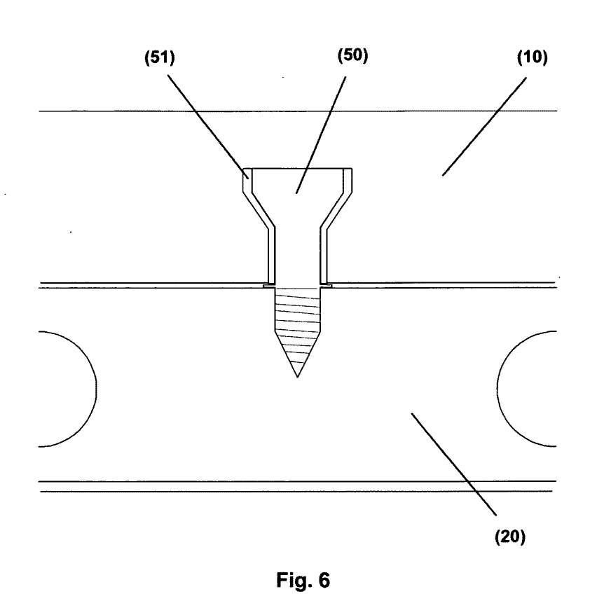

In cases where the hold strength of connecting device is not critical and the concrete slab (10) has slight shrinkage movement, the modified head screw (50) with the elastic covering (51) can be used as illustrated in FIG. 6.

What is claimed is:

1. A lightweight and thermal efficient concrete panel comprising: (a) a concrete slab; (b) a standard metal stud frame with a plurality of parallel spaced apart steel stud members; (c) insulating strips with adhesive backing; and (d) anchoring blind rivets or engineered screws with elastic cover as the concrete-to-frame connecting devices.

2. A lightweight and thermal efficient concrete panel according to claim 1 wherein the insulating strips with adhesive backing are made of any extrudable insulating material having thickness at least 1/16″ and width equal to or greater than the stud flange.

3. A lightweight and thermal efficient concrete panel according to claim 1 wherein the metal stud members of the standard metal stud frame are the standard C-section studs with pre-punched holes for anchoring blind rivets or screws to go through.

4. A lightweight and thermal efficient concrete panel according to claim 1 wherein the anchoring blind rivet is made of any type of steel, has a protruding and shaped head that effectively acts as anchor embedded in the concrete slab, and has an optional elastic cover over its head that allows the concrete slab to move slightly.

5. A lightweight and thermal efficient concrete panel according to claim 1 wherein the engineered screw has an elastic cover over its embedded head to allow slight movement of the concrete slab.

6. A lightweight and thermal efficient concrete panel according to claim 1 wherein the anchoring blind rivet's protruding portion of the rivet is the rivet body shaped to effectively act as anchor in the hardened concrete.

7. A lightweight and thermal efficient concrete panel according to claim 1 wherein the anchoring blind rivet's protruding portion of the rivet is the rivet body and the mandrel shaped to effectively act as anchor in the hardened concrete.

8. A lightweight and thermal efficient concrete panel according to claim 1 wherein the anchoring blind rivet's protruding portion of the rivet is the mandrel shaped to effectively act as anchor in the hardened concrete.

9. A lightweight concrete panel comprising: (a) a concrete slab; (b) a standard metal stud frame with a plurality of parallel spaced apart steel stud members; and (c) anchoring blind rivets with protruding head or engineered screws with elastic covers as the concrete-to-frame connecting devices.

10. A lightweight concrete panel according to claim 9 wherein the metal stud members of the standard metal stud frame are the standard C-section studs with pre-punched holes for anchoring blind rivets or screws to go through.

11. A lightweight concrete panel according to claim 9 wherein the anchoring blind rivet is made of any type of steel, has a protruding and shaped head that effectively acts as an anchor embedded in the concrete slab, and has an optional elastic cover over its head that allow the concrete slab to move slightly.

12. A lightweight concrete panel according to claim 9 wherein the engineered screw has an elastic cover over its embedded head to allow slight movement of the concrete slab.

13. A steel blind rivet used as a concrete-to-steel frame connecting device wherein the anchoring blind rivet attached to the steel frame has a protruding and shaped head that effectively acts as an anchor when the head is embedded in the concrete.

14. The anchoring blind rivet according to claim 13 wherein the anchoring blind rivet has an elastic cover over the embedded head to allow slight movement in the concrete slab.

15. The anchoring blind rivet according to claim 13 wherein the anchoring blind rivet body is comprised of two ordinary blind rivet bodies where the main smaller rivet body fits inside the larger and shorter rivet body with heads in opposite ends to form the protruding rivet head of the anchoring blind rivet.

16. The anchoring blind rivet according to claim 13 wherein the anchoring blind rivet body is comprised of a shorter slotted pin or sleeve wrapped tightly over the longer blind rivet body to form the protruding rivet head of the anchoring blind rivet.

17. The anchoring blind rivet according to claim 13 wherein the anchoring blind rivet body is one piece having smaller outside diameter portion at the connecting end, then steps up to a larger diameter portion at the protruding end.

18. The anchoring blind rivet according to claim 13 wherein the protruding portion of the blind rivet is both the rivet body and mandrel shaped effectively to anchor in the hardened concrete.

19. The anchoring blind rivet according to claim 13 wherein the protruding portion of the blind rivet is the mandrel shaped effectively to anchor in the hardened concrete.

20. A bent steel anchoring bracket used as a concrete-to-steel frame connecting device wherein the anchoring bracket is fastened to steel frame via ordinary blind rivets and wherein the bent ends of the anchoring bracket have various shapes to anchor itself in the concrete.
